(19) United States
(12) Patent Application Publication
(10) Pub. No.: US 2009/0063158 A1
(43) Pub. Date: Mar. 5, 2009

(54) EFFICIENT AUDIO CODING USING SIGNAL PROPERTIES

(75) Inventors: Tor Johan Fredrik Norden, Aalborg (DK); Soren Vang Andersen, Aalborg (DK); Soren Holdt Jensen, Gistrup (DK); Willem Bastiaan Kleijn, Stocksund (SE); Nicolle Hanneke Van Schijndel, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/718,242

(22) PCT Filed: Nov. 2, 2005
(86) PCT No.: PCT/IB05/53570

§ 371 Date: Apr. 30, 2007

(30) Foreign Application Priority Data
Nov. 5, 2004 (EP) 04105545.0

(51) Int. Cl. G10L 19/00

(52) U.S. Cl. 704/500

(57) ABSTRACT

An audio encoder comprising optimizing means ET OPT adapted to generate an optimized encoding template OET based on properties PV of an input audio signal IN, such as in form of a property vector. The optimized encoding template OET is being optimized with respect to a predetermined encoding efficiency criterion. Encoding means ENC then generates an encoded audio signal OUT in accordance with the optimized encoding template OET. The audio encoder may comprise analyzing means AN adapted to generate the set of input signal properties PV based of the input signal IN. In a preferred embodiment the optimizing means ET OPT is adapted to estimate a resulting distortion associated with an encoding template. The optimizing means ET OPT may further be able to estimate bit rate associated with an encoding template. In one embodiment the optimizing means ET OPT is adapted to optimize a bit rate distribution to a number of sub-encoders based on the input signal properties (PV). In another embodiment, the optimizing means ET OPT is adapted to up-front decide on an adaptive segmentation based on the input signal properties (PV). The encoders according to the invention are advantageous in that complex processes of a plurality of encodings prior to deciding upon an optimized encoding template OET can be avoided since the optimal encoding template OET is found based on input signal properties (PV).

The invention relates to high efficiency, high quality audio signal coding. More specifically, the invention relates to the class of audio codecs which are adaptive to an input signal, i.e. having a number of encoding settings to be optimised for obtaining encoded signal being optimal in terms of a rate-distortion criterion. The invention provides an audio encoder and a method of optimising audio encoder settings.

A crucial problem within encoding is to find the most efficient representation for each input signal. Since audio signals can exhibit a wide range of characteristics and, for different signal characteristics, different encoding methods are most efficient, it is desirable to use flexible codecs, e.g. codecs that combine different encoding methods. For example, audio signals are split and encoded as a sinusoidal part and a residual. Usually, tonal signals are coded with a specific coding method aimed at signals made up out of sinusoids and the residual signal is encoded with a waveform or noise encoder. Consequently, within such codecs it has to be decided which settings (or which encoding template) to use, e.g. which part of the signal to encode by which encoding method. Such decision can be based on the full input signal, i.e. the input signal itself, and after trying many encoding possibilities, calculating for each possibility the resulting (perceptual) distortion. However, with the emerged flexible and adaptive codecs that combine many different encoding methods and therefore have a large number of possible settings, the decision about encoding settings becomes a problem regarding complexity.

Also in most codecs with only one coding method decisions have to be made, such as with respect to the encoder settings that may be different for different parts of the input signal. This is for example the case in codecs with adaptive time segmentation. Segmentation can be adapted by means of rate-distortion optimisation, but this increases complexity significantly. Another example can be found in parametric, sinusoidal coding. There it has to be decided how many sinusoids to allocate to a particular segment, the optimal number depending on the input signal. Also in transform or sub-band codecs decisions must be made with respect to the quantisation levels and scale factor bands (a group of frequency bands coded with the same quantisation levels). These decisions are based on the full input signal, considering the corresponding coding errors in the different frequency bands.

Patent application US 2004/0006644 describes a method of transcoding an input signal. Different transcoding methods can be selected depending on the input signal to be transcoded. In US 2004/0006644 it is proposed to select between different methods based on prior established properties of the input signal to be transcoded. However, US 2004/0006644 does not disclose any method for optimising encoder settings.

In conclusion, the state of the art does not satisfactorily answer how to determine the optimum encoder settings or which encoding method can best code which part of the input signal. Therefore, within the field of high quality audio coding there is a need for a method of efficiently optimising an encoding template (or encoder settings) so as to adapt the encoding to an input signal.

Thus, it may be seen as an object of the present invention to provide an audio encoder and an audio encoding method capable of providing a low complexity optimizing of an encoder template and yet provide an encoded signal which is efficient in terms of a rate-distortion criterion.

According to a first aspect the invention provides an audio encoder adapted to encode an audio signal according to an encoding template, the audio encoder comprising:

optimizing means adapted to generate an optimized encoding template based on a predetermined set of properties of the audio signal, the optimized encoding template being optimized with respect to a predetermined encoding efficiency criterion, and

encoding means adapted to generate an encoded audio signal in accordance with the optimized encoding template.

By the term ‘encoding template’ is understood the set of parameters, i.e. settings, that has to be selected for a specific encoder. By ‘optimized encoding template’ it is to be construed an encoding template wherein some or all parameters are selected or modified in response to the predetermined set of properties of the audio signal so as to result in an encoded output signal which is more optimal in terms of the predetermined encoding efficiency criterion. By ‘predetermined set of properties of the audio signal’ is understood a parametric description of the audio signal comprising one or more parameters descriptive of signal properties of the audio signal. The predetermined set of properties of the audio signal may e.g. be in form of a property vector with scalar values representing each parameter.

By using a predetermined set of properties of the audio signal, e.g. by means of a property vector, the audio encoder is capable of optimizing the encoding template to be used for the encoding process by using prior knowledge of relevant properties of the audio signal to be encoded. Thus, preferably the audio encoder estimates a rate and/or distortion measure based on the predetermined set of properties of the audio signal and hereby provides an optimized encoding template without actually encoding the audio signal. In other words, using e.g. an input signal property vector, decisions regarding optimal encoder settings can be performed without the need for trying a large number of possible settings and monitor a resulting encoded output signal with respect to rate and distortion before a final decision on an optimal encoding template can be made.

This enables an encoder with a low complexity for encoding template optimizing compared with traditional encoders. This is especially advantageous for encoding schemes which have encoding templates comprising a large set of parameters to be optimized in order to achieve an optimum rate-distortion efficiency. An example is the class of encoders comprising two or more sub encoders and where at least one task is to decide about a bit rate distribution between the sub encoders in order to obtain an optimal rate-distortion efficiency. Although an exhaustive search among all possible encoding templates using the full input signal and a (perceptual) distortion measure would be optimal, this is probably inefficient and far too complex to be realisable with a limited amount of processing power available.

It is to be understood that data representing the set of properties of the audio signal can be arranged in any convenient fashion, such as property vector or property matrix.

The audio encoder may comprise analysis means adapted to analyze the audio signal and generate the set of properties of the audio signal in response thereto. However, the set of properties of the audio signal may be established outside the audio encoder. The audio encoder is then adapted to receive as input the audio signal together with the predetermined set of properties of the audio signal.

Preferably, the optimizing means comprises means adapted to predict a perceptual distortion associated with the encoding template based on the predetermined set of properties of the audio signal. By ‘distortion associated with the encoding template’ is understood a resulting difference between the encoded audio signal and the audio signal itself by encoding the audio signal according to the encoding template. By ‘perceptual distortion’ is understood a measure of distortion relevant with respect to what is perceived by the human auditory system, i.e. a measure of distortion that reflects a perceived sound quality. Preferably, the perceptual distortion measure is based on a perceptual model, such as a representation of the human masking curve etc.

Preferably, the optimizing means comprises means adapted to predict a bit rate associated with the encoding template based on the predetermined set of properties of the audio signal.

Most preferably, the optimizing means is adapted to predict both a perceptual distortion and a bit rate associated with the encoding template based on the predetermined set of properties of the audio signal. Hereby the encoder is capable of optimizing the encoding template according to a criterion being the best sound quality at a given maximum target bit rate or the lowest possible bit rate at a predetermined minimum sound quality in terms of perceptual distortion.

Preferably the set of properties of the audio signal comprises at least one property selected from the group consisting of: tonality, noisiness, harmonicity, stationarity, linear prediction gain, long-term prediction gain, spectral flatness, low-frequency spectral flatness, high-frequency spectral flatness, zero crossing rate, loudness, voicing ratio, spectral centroid, spectral bandwidth, a Mel cepstrum, frame energy, spectral flatness for ERB bands 1-10, spectral flatness for ERB bands 10-20, spectral flatness for ERB bands 20-30, and spectral flatness for ERB bands 30-37. Preferably, the predetermined set of properties of the audio signal comprises a property vector with scalars representing one or more of the mentioned parameters. It is to be understood that several other types of parameters may be used, however. In principle any signal describing parameter may be selected. However, preferably the predetermined set of properties of the audio signal comprise perceptually relevant properties, i.e. properties that are relevant with respect to what is perceived by the human auditory system.

The predetermined set of properties of the audio signal may comprise properties that can be determined by standard definitions known in the art.

It may be preferred that the set of audio signal properties is specifically designed to take into account relevant properties for a specific encoder in question. E.g. tonality and noisiness parameters may be included in case of a combined encoder having a sinusoidal encoder part and a noise encoder part. Hereby a bit rate distribution task becomes simple and is easily determined from the tonality and noisiness parameter. E.g. a very simple decision criterion may be to select the sinusoidal encoder part in case the tonality parameter exceeds a certain value, otherwise the noise encoder part is selected. However, it is to be understood that based on prior knowledge of the specific encoder in question it is possible to precisely predict encoding behavior even with only one, two or a few parameters to describe the audio signal.

Preferably, the audio encoder is adapted to optimize the encoding template for each segment of the audio signal. Thus, the encoder being able to track rapid changes in the audio signal, such as transients, and adapt its encoding template accordingly.

The optimizing means may be adapted to optimize a segmentation of the audio signal based on the set of properties of the audio signal. Apart from the encoding template it has proven to be encoding efficient to use adaptive segmentation. Using an up-front adaptive segmentation based on signal properties of the audio signal such adaptive segmentation becomes even more efficient, since in prior art encoders adaptive segmentation only adds an extra and complex optimizing task apart from optimizing the encoding template.

The optimizing means may be adapted to select the optimized encoding template from a set of predefined encoding templates. In order to further facilitate the encoding template optimizing process, it may be preferred that the predefined set of encoding templates covers the majority of the entire encoder parameter space. The optimizing task may then be to evaluate the predefined set of encoding parameters and select the best one in terms of the predetermined encoding efficiency criterion.

In a preferred embodiment the encoding means comprises first and second sub-encoders, while the optimizing means is adapted to optimize first and second encoding templates for the first and second sub-encoders in response to the predetermined set of properties of the audio signal. If preferred, the audio encoder may comprise three, four, five, ten or even more separate sub-encoders and be adapted to optimize encoding templates for all sub-encoders based on the predetermined set of properties of the audio signal. Thus, this embodiment covers combined codecs.

In a second aspect the invention provides a method of encoding an audio signal, the method comprising the steps of:

generating an optimized encoding template based on a predetermined set of properties of the audio signal, the optimized encoding template being optimized with respect to a predetermined encoding efficiency criterion, and

generating an encoded audio signal in accordance with the optimized encoding template.

The same explanation and preferred variants as described above for the first aspect of the invention apply for the second aspect as well.

In a third aspect the invention provides a method of optimizing an encoding template of an audio encoder adapted to encode an audio signal, the method comprising the steps of:

receiving a predetermined set of properties of the audio signal,

optimizing the encoding template with respect to a predetermined encoding efficiency criterion, based on the predetermined set of properties of the audio signal.

Optimizing the encoding template for the encoder based on the predetermined set of properties of the audio signal, such as using a property vector, makes the optimizing considerably less complex than prior art methods of optimizing encoding templates. The reason is that prior art methods of optimizing encoding efficiency are based on necessary bit rate and a resulting distortion obtained for an actually encoded audio signal. Thus, such prior art methods involve the encoding process. By an optimizing method based on a predetermined set of properties of the audio signal the encoding process in the optimizing method is eliminated. This is especially advantageous in encoder with a large number of settings to be optimized. Instead the optimizing may be based on a prediction of a perceptual distortion measure and a prediction of a bit rate for a given encoding template.

Although not as accurate as actually encoding a signal according to the encoding template, prediction accuracy can be improved by carefully considering e.g. which data to include in the predetermined set of properties of the audio signal and establishing a precise model of the encoder(s) in questions. For complex set of combined encoders each having a large number of possible settings, prior art methods may provide poor results as it may not be possible to actually test the entire parameter space but only a very coarsely cover the parameter space. In contrast, predictions may prove to be fast enough to cover the entire parameter space and thus end up with an encoding template closer to the theoretically optimum, provided a given computation power available.

The method according to the third aspect may comprise an initial set of analyzing the audio signal and generate the set of predetermined properties of the audio signal in accordance therewith.

Preferably, the optimizing step comprises predicting a perceptual distortion measure (see the above definitions).

Preferably, the optimizing step comprises predicting a bit rate. Preferably, the optimizing step comprises predicting of both a perceptual distortion and a bit rate so as to enable an optimization of the encoding template according to a criterion being the best sound quality at a given maximum target bit rate or the lowest possible bit rate at a predetermined minimum sound quality in terms of perceptual distortion.

Preferably, the optimizing method is performed for each segment of the audio signal.

Preferably, the optimizing method comprises optimizing segmentation of the audio signal based on the predetermined set of properties of the audio signal.

In a fourth aspect the invention provides a device comprising an audio encoder according to the first aspect. Such device is preferably an audio device such as a solid state audio device, a CD player, a CD recorder, a DVD player, a DVD recorder, a harddisk recorder, a mobile communication device, (portable) computers etc. However, the device may also be devices other than audio devices.

In a fifth aspect the invention provides a computer readable program code adapted to encode an audio signal according to the method of the second aspect.

In a sixth aspect the invention provides a computer readable program code adapted to optimize an encoding template according to the method of the third aspect.

The computer readable program code according to the fifth and sixth aspects may comprise software algorithms adapted for a signal processor, personal computers etc. It may be present on a portable medium such as a disk or memory card or memory stick, or it may be present in a ROM chip or in other way stored in a device.

In the following the invention is described in more details with reference to the accompanying Figures of which

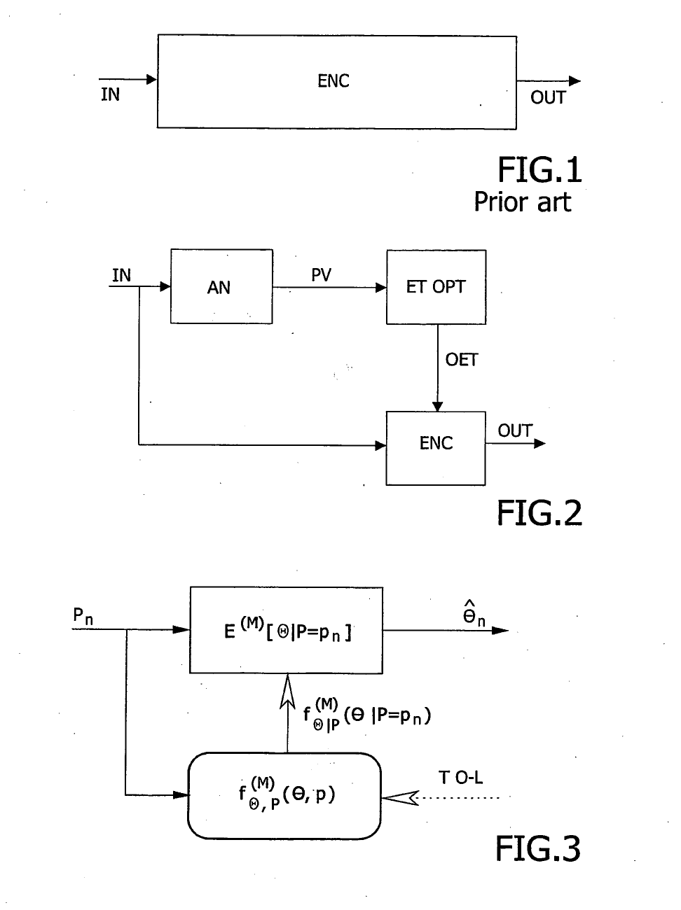

FIG. 1 illustrating a prior art encoder where encoding settings are either fixed or iteratively adjusted based on a resulting distortion of the encoded signal,

FIG. 2 illustrates an encoder according to the invention, where a decision of encoder settings is based on a prior analysis of an input signal,

FIG. 3 illustrates a preferred Gaussian mixture based minimum mean square error (MMSE) estimator for estimating encoding distortion,

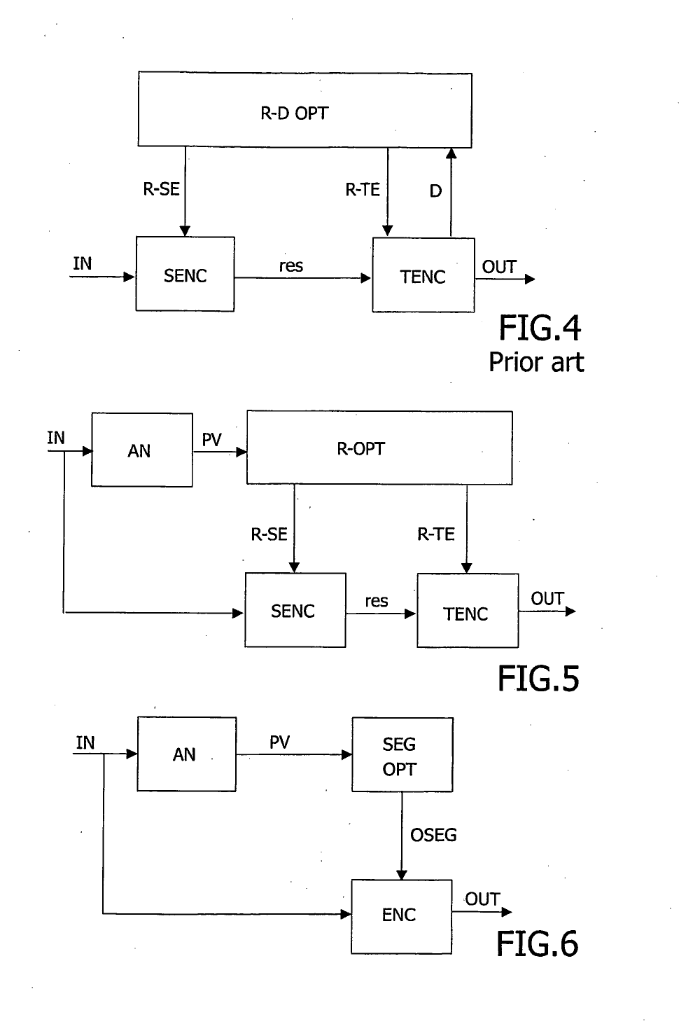

FIG. 4 illustrates a prior art combined encoder where bit rate distribution between two sub encoders is decided upon by evaluating distortion of the encoded signal,

FIG. 5 illustrates a combined encoder according to the invention, where bit rate distribution between two sub encoders is decided upon based on properties of the input signal,

FIG. 6 illustrates an encoder according to the invention, where an adaptive segmentation of the input signal is decided upon based on properties of the input signal.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

FIG. 1 illustrates a prior art encoder ENC that receives an input signal IN and generates an encoded output signal OUT in response thereto. In the prior art encoder ENC encoder settings or an encoding template is either fixed or based on an optimising algorithm involving an encoding of the input signal. Different encoding templates are tried, each involving an encoding of the input audio signal IN, and for each encoding template e.g. distortion and bit rate associated with each encoding template is monitored, and finally the most efficient encoding template is selected to be used to generate the output signal OUT.

FIG. 2 illustrates the principle of the invention by means of a preferred audio encoder embodiment. An input audio signal IN is received and analysed by signal analysing means AN. The analysing means AN generates in-response a property vector PV comprising a set of properties of the audio signal IN. This property vector PV is then received by an encoding template optimising unit ET OPT that generates an optimised encoding template OET based on the received property vector PV. The optimised encoding template OET and the input audio signal IN are then used by an encoder means ENC to generate an encoded output signal OUT being an encoded version of the input audio signal IN.

Thus, in the audio encoder of FIG. 2 the property vector PV and a mathematical model of the different encoding configurations, for example its rate-distortion performance, is used to generate the optimised encoding template OET. Then, it is not necessary to try all possible encoding templates, because the property vector PV already indicates the input-type-dependent performance of the encoding templates. In contrast to the prior art encoder of FIG. 1, the audio encoder according to the invention is capable of optimising an encoding template for the encoder means without having to encode the input audio signal IN but is capable of deciding upon an optimal encoding template using properties of the input audio signal IN only.

It is to be understood that the analysing means AN shown in the diagram of FIG. 2 is optional. Thus, an audio encoder according to the invention may be adapted to receive as inputs the input audio signal IN and a property vector PV.

The application of a property vector PV is efficient and reduces complexity in the optimising process. A disadvantage of the use of a property vector PV may be that encoding becomes (slightly) suboptimal. However, the ad-hoc methods currently in use in audio coding are most likely much further from an optimal solution.

The application of a predetermined set of properties of an input audio signal can be used in several ways, which can be used simultaneously. They will be further described in the following. For simplicity reasons a predetermined set of properties of an input audio signal is denoted a property vector in the following.

In a first embodiment, a property vector is used to estimate distortions, such as a perceptual distortions, for different encoding templates. E.g. the combination of different encoding methods or different settings within one encoding method. This has two advantages in terms of complexity: 1) no actual encoding necessary, 2) no need for calculations of the (perceptual) distortion. In other words, the property vector is used to obtain (perceptual) distortions without actual encodings and calculations of the corresponding distortion.

In a second embodiment, a property vector is used to determine directly which part of an input signal to code by which encoding method in a hybrid encoder, i.e. in an encoder comprising a combination of several encoding methods or sub-encoders. This goes one step further than the previous item: in this case, the property vector does not only indicate the input-type-dependent performance of the coding methods, but also indicates which one(s) to use.

For example, if the input signal has a prominent sinusoid, it is not necessary to encode this with all encoding methods and choose the most efficient one. In contrast, the property vector indicates that the signal contains a prominent sinusoid and thus, it is sufficient to check which encoding method can efficiently encode sinusoids, such as a sinusoidal encoder, and then start with that one. Thus, looking at the property vector, it is immediately clear, without actually encoding, which encoding method can most efficiently encode (parts of) the input signal. The property vector can also be used to estimate potential interactions between the coding methods. Knowledge about these interactions is also important for efficient configuration of the codec.

In a third embodiment, a property vector is to estimate an optimal time-variant adaptive segmentation of codecs. By means of a property vector the adaptive segmentation can be set up-front based on the time-varying characteristics of the input signal, which leads to lower complexity compared to methods that explore the effect of several segmentation possibilities.

The three mentioned embodiments will now be described in more details.

The first embodiment is a property vector based scheme for instantaneous distortion estimation. The framework is based on a property vector extracted from the frame to be encoded, from which the distortion estimation is to be performed. In more detail, the task of estimating the incurred coding distortion, θ, for a coder Q(.) is addressed. For a given frame x, the incurred distortion is expressed as

θ=δ(x,\tilde{x})=δ(x,Q(x)), (1)

where δ(.,.) is an appropriate distortion measure.

The estimation is separated into a property extraction, f(.), and an estimation, g(.). The random input vector X is processed into a dimension reduced random vector P, from which an estimate, \hat{Θ}, of the coding distortion, Θ, is to be found. The aim of the scheme is to perform an unbiased estimate, and to minimise the estimation error variance,

σ_{Z}²=E[(Z)²]=E[(Θ−\hat{Θ})²]=E[(Θ−g(P))²]. (2)

The performance of such a scheme is highly dependent on the choice of property vector. Thus, the basic task for the property extractor, f(.), is to extract properties, P, that contain sufficient information about Θ for a required estimator accuracy, σ_{Z}², i.e. sufficiently high mutual information, I(Θ;P) such as found in T. M. Cover and J. A. Thomas, Elements of Information Theory, John Wiley & Sons, New York, N.Y., 1991.

The aim of the estimator, g(.), is to find an estimate, \hat{θ}, of the incurred distortion, θ, based on an observation of the property vector P=p. The minimum mean square error estimator (MMSE) for this task, i.e., the one minimising σ_{Z}², is the conditional mean estimator,

\hat{θ}ₘₘₛₑ=E[Θ|P=p]=∫θf_{Θ|P}(θ|P=p)dθ (3)

FIG. 3 illustrates the chosen implementation using a model-based approach as described in J. Lindblom, J. Samuelsson, and P. Hedelin, “Model based spectrum prediction,” in Proc. IEEE Workshop Speech Coding, (Delawan, Wis., USA), 2000, pp. 117-119. In FIG. 3 T O-L indicates that the joint pdf, f_{Θ,P}^{(M)}(θ, p), is off-line trained.

Employing a Gaussian mixture model (GMM) for the joint pdf, f_{Θ,P}^{(M)}(θ, p), the MMSE at each coding instant is approximated as

\hat{θ}=g(p)=∫θf_{Θ|P}^{(M)}(θ|P=p)dθ (4)

where f_{Θ,P}^{(M)}(θ|P=p) is the conditional model pdf, which can be shown to be a mixture of Gaussian densities, and is easily derived from the joint model pdf, f_{Θ,P}^{(M)}(θ, p). In practice, this estimator calculates a weighted sum of conditional means,

$$\hat{θ} = {\sum }_{i = 1}^{M} {ρ}_{i}^{′} {m}_{i , Θ \vert P = p} , \qquad ( 5 )$$

where M is the number of mixture components, and {ρ′ᵢ} and {m_{i,Θ|P=p}} represent the weights and the means of the conditional model pdf, f_{Θ,P}^{(M)}(θ|P=p), respectively. The estimator output will approach the true conditional mean, c.f. Eq. (3), as the model pdf approaches the true pdf.

The complexity reduction obtained by distortion estimation instead of encoding and distortion calculation depends on 3 factors: the complexity of the distortion estimation using a property vector, the complexity of the encoding method, and the complexity of distortion calculation.

The complexity of the distortion estimation obviously depends on the model that is used. For the embodiment presented above, assuming each RD point is estimated independently, the complexity can be stated as: N_{RD}·Nₘᵢₓₜ·(C_{product}+C_{pdf}), in which N_{RD} is the number of RD points, Nₘᵢₓₜ is the number of mixtures, C_{product} is the complexity of the matrix vector product, and C_{pdf} is the complexity of the Gaussian pdf evaluation. The matrix vector product has the ‘dimension’ of the employed property vector, but the matrix is symmetric and the complexity can thus be reduced to approximately half of that.

The complexity of the encoding method obviously depends on the method that is used and widely varies from codec to codec. Nevertheless, this complexity is expected to be higher than that of the distortion estimation.

The implemented estimation scheme has been evaluated for a Code-Excited Linear Prediction (CELP) like encoder, Q(.), using the incurred Signal to Noise Ration (SNR) as the distortion to be estimated, Θ. It has been tested for six different property vectors: the 10th order linear prediction gain (G_{LPC}), the long-term prediction gain (G_{LTP}), spectral flatness (G), low-frequency spectral flatness (G_{low}), high-frequency spectral flatness G_{high}, and the combination of LPC and LTP gain (G_{LPC}G_{LTP}). All estimators were based on 32-mixture models, and the results were evaluated on the Timit speech database, using separate evaluation and training sets.

The results were that the estimation error variance σ_{Z}² decreased as the mutual information, I(Θ; P), was increased in the employed property vector, P. Thus, closeness to the true distortion increased with the mutual information, I(Θ; P), of the employed property vector. The results showed that a high accuracy estimation can be performed, given a property vector with sufficiently high mutual information, I(Θ; P). The results confirmed the feasibility of the using a property vector to indicate the input-type-dependent performance of encoding configurations, thereby reducing complexity.

The property vector scheme has also been evaluated for a sinusoidal encoder, using 30 sinusoids per frame. The encoder is based on psycho-acoustical matching pursuit as found in R. Heusdens and S. van de Par, “Rate-distortion optimal sinusoidal modeling of audio and speech using psychoacoustical matching pursuits,” in Proc. IEEE Int. Conf. Acoust., Speech, and Signal Proc., (Orlando, Fla., USA), 2002, vol. 2, pp. 1809-1812, using a perceptual spectral distortion measure as found in S. van de Par, S. Kohlrausch, A. Charestan, and R. Heusdens, “A new psychoacoustical masking model for audio coding applications,” in Proc. Proc. IEEE Int. Conf. Acoust., Speech, and Signal Proc., (Orlando, Fla., USA), 2002, vol. 2, pp. 1805-1808, as the distortion to be estimated, Θ.

It was tested for eight different property vectors: zero crossing rate (ZCR), loudness (L), voicing ratio (V), spectral centroid (SC), spectral bandwidth (B W), spectral flatness (SF), a 12 order Mel cepstrum (MFCC), and a 4 dimensional property vector, based on the combination L+SF+SC+BW. All estimators were based on 16-mixture models, and the results were evaluated on an audio database containing 900.000 frames of 35 ms, separated into an evaluation and a training set. Also for this implementation the results indicated that it is possible to estimate the distortion with a high accuracy, given a property vector with sufficiently high mutual information, I(Θ; P).

In the following the second embodiment will be described where a property vector is used to determine which part of an input signal to be encoded by which encoding method in a hybrid encoder.

The hybrid encoder of the embodiment comprises two encoding methods: a sinusoidal encoder followed by a transform encoder. The sinusoidal encoder is similar to the one described in connection with the first embodiment. The transform encoder is based on an MDCT filter bank, such as found in R. D. Koilpillai and P. P. Vaidyanathan, “Cosine-modulated fir filter banks satisfying perfect reconstruction,” IEEE Trans. Signal Processing, vol. 40, no. 4, pp. 770-783, April 1992, and codes the residual of the sinusoidal encoder. The key question is which signal component to encode by the sinusoidal encoder and which component by the transform encoder. In this embodiment, this question translates to which part of the available bit budget to spend by the sinusoidal encoder and which part by the transform encoder.

FIG. 4 illustrates a prior art approach. An input signal IN is applied to a sinusoidal encoder SENC that delivers a residual signal res to a transform encoder TENC that is thus intended to encode what the sinusoidal encoder SENC can not encode. A rate-distortion optimising unit R-D OPT distributes bit rates R-SE and R-TE for the two encoders SENC, TENC, respectively. In response, the optimising unit R-D OPT receives a resulting distortion D from the last encoder TENC. Several different bit distributions R-SE, R-TE are tried and the optimal one is then chosen by the rate-distortion optimising unit R-D OPT, i.e. the one resulting in the lowest distortion D, and this distribution R-SE, R-TE is then used to generate an encoded output signal OUT.

In the chosen example the following bit distributions are tried: 100% to the sinusoidal encoder (SENC) and 0% to the transform encoder (TENC), 75% SENC and 25% TENC, 50% SENC and 50% TENC, 25% SENC and 75% TENC, 0% SENC and 100% TENC. The signal is encoded using the different bit distributions and from the resulting parameters a signal is synthesis to determine the corresponding perceptual distortion. For this, the perceptually-relevant distortion measure found in S. van de Par, A. Kohlrausch, G. Charestan and R. Heusdens, “A new psychoacoustical masking model for audio coding applications,” in Proc. Proc. IEEE Int. Conf. Acoust., Speech, and Signal Proc., (Orlando, Fla., USA), 2002, vol. 2, pp. 1805-1808, is used, which utilises the spectral auditory masking properties of the input signal. The optimisation algorithm selects that bit distribution that results in the lowest perceptual distortion.

FIG. 5 illustrates an approach according to the invention. The difference from the prior art approach of FIG. 4 is that a property vector PV, as described above, is input to a bit rate optimising unit R-OPT that determines optimal bit distributions R-SE, R-TE to the two encoders SENC, TENC. In the shown embodiment an analysing unit AN analyses the input signal IN and generates the property vector PV in response thereto. Instead of trying different bit distributions, the optimal distribution R-SE, R-TE is estimated using this property vector PV.

To determine which properties are useful for this task, twelve property vectors have been examined: eight 1-dimensional vectors (zero crossing rate, loudness (L), voicing ratio, spectral centroid, spectral bandwidth (BW), spectral flatness, frame energy, LPC flatness), two 4-dimensional vectors (L+BW and SFERB: spectral flatness for ERB band 1-10, 10-20, 20-30, 30-37), one 8-dimensional vector based on the combination of the two 4 dimensional property vectors, and one 12-dimensional vector (a 12 order Mel cepstrum). A Gaussian mixture model is used to estimate the bit distributions, such as described above. All estimators are based on 32-mixture models, which are trained using an audio database containing 6.000 frames of 43 ms. The best results are obtained by using the multi-dimensional property vectors. Therefore the 4 dimensional property vector SFERB is used for the evaluation using a different database than the one used for training.

A comparison of the two approaches of FIGS. 4 and 5 has been performed. The resulting perceptual distortions have been determined per frame, using the distortion measure found in S. van de Par, A. Kohlrausch, G. Charestan and R. Heusdens, “A new psychoacoustical masking model for audio coding applications,” in Proc. Proc. IEEE Int. Conf. Acoust., Speech, and Signal Proc., (Orlando, Fla., USA), 2002, vol. 2, pp. 1805-1808. The two approaches result in similar distortions, indicating the feasibility of using a property vector for determining bit distributions.

However, the embodiment presented in FIG. 5 may be improved in several ways, for example by using better properties or improving the Gaussian mixture model illustrated in FIG. 3. Examples of the latter are: using more mixtures, limiting the possible outcomes of the estimator between 0 and 100% (the current estimator is based on Gaussians, and a Gaussian can take any value), changing the task of the model (instead of estimating percentages in-between 0-100%, one could classify frames into classes: 0, 25, 50, 75, 100%). And another model can be used instead of the Gaussian mixture model.

The use of a property vector PV for estimation of bit distributions R-SE, R-TE among the different codec strategies SENC, TENC reduces computational complexity significantly compared to a codec in which this distribution is determined by means of rate-distortion optimisation. In the mentioned embodiment complexity is reduced by a factor equal to the number of bit distributions examined in the optimisation. So, complexity is reduced by a factor of 5 in the mentioned example.

FIG. 6 illustrates the third embodiment, a property vector PV based scheme to determine an up-front optimised segmentation OSEG adapted to the input signal IN.

Decisions in a segmentation optimising unit SEG OPT with respect to the adaptive segmentation OSEG are based on the property vector PV and on a model of the different segmentations, for example their rate-distortion performance. The optimised segmentation OSEG is then applied to the encoder ENC together with the input signal IN, and an encoded output signal OUT can be generated. Then it is not necessary to encode all different segmentation possibilities, because the property vector PV already indicates the input-type-dependent performance of the segmentations.

Actually, the use of a property vector for up-front segmentation is similar to that of rate-distortion estimation. In the same way as described for the first embodiment, the property vector can be used to estimate the rate-distortion performance of different segmentation possibilities, choosing the one with the best performance.

The use of a property vector for up-front adaptive time segmentation reduces computational complexity significantly compared to rate-distortion by means of full rate-distortion optimisation. Complexity is reduced by a factor about equal to the number of different segment lengths allowed (ignoring the extra complexity introduced by the property vector). For example, assuming that in a sinusoidal encoder with adaptive segmentation 4 different segment lengths are allowed: 10.7, 16.0, 21.3 and 26.8 ms. Then, complexity is reduced by a factor of 4 by up-front segmentation.

As will be understood the encoding principles according to the invention may be applied within a large range of applications, such as solid state audio devices, CD players/recorders, DVD players/recorders, mobile communication devices, (portable) computers, multimedia streaming of audio such as on the internet etc.

In the claims reference signs to the Figures are included for clarity reasons only. These references to exemplary embodiments in the Figures should not in any way be construed as limiting the scope of the claims.

1-13. (canceled)

14. An audio encoder adapted to encode an audio signal (IN) according to an encoding template, the audio encoder comprising
optimizing means (ET OPT) adapted to generate an optimized encoding template (OET) based on a predetermined set of properties (PV) of the audio signal (IN) by performing a mathematical optimizing algorithm on a mathematical model of the audio encoder with the predetermined set of properties (PV) of the audio signal (IN) as input, for optimizing the encoding template with respect to a predetermined encoding efficiency criterion, and
encoding means (ENC) adapted to generate an encoded audio signal (OUT) in accordance with the optimized encoding template (OET).

15. An audio encoder according to claim 14, further comprising analysis means (AN) adapted to analyze the audio signal (IN) and generate the set of properties (PV) of the audio signal (IN) in response thereto.

16. An audio encoder according to claim 14, wherein the optimizing means (ET OPT) comprises means adapted to predict a perceptual distortion associated with the encoding template based on the predetermined set of properties (PV) of the audio signal (IN).

17. An audio encoder according to claim 14, wherein set of properties (PV) of the audio signal (IN) comprises at least one property selected from the group consisting of: tonality, noisiness, harmonicity, stationarity, linear prediction gain, long-term prediction gain, spectral flatness, low-frequency spectral flatness, high-frequency spectral flatness, zero crossing rate, loudness, voicing ratio, spectral centroid, spectral bandwidth, a Mel cepstrum, frame energy, spectral flatness for ERB bands 1-10, spectral flatness for ERB bands 10-20, spectral flatness for ERB bands 20-30, and spectral flatness for ERB bands 30-37.

18. An audio encoder according to claim 14, adapted to optimize the encoding template for each segment of the audio signal.

19. An audio encoder according to claim 14, wherein the optimizing means (ET OPT) further comprises means adapted to predict a resulting bit rate associated with the encoding template, based on the set of properties (PV) of the audio signal (IN).

20. An audio encoder according to claim 14, wherein the optimizing means (ET OPT) is adapted to optimize a segmentation of the audio signal based on the set of properties (PV) of the audio signal.

21. An audio encoder according to claim 14, wherein the encoding means comprises first (SENC) and second (TENC) sub-encoders, and wherein the optimizing means (R-OPT) is adapted to generate optimized first (R-SE) and second (R-TE) encoding templates for the first (SENC) and second (TENC) sub-encoders in response to the predetermined set of properties (PV) of the audio signal (IN).

22. An audio encoder according to claim 14, wherein the mathematical optimization algorithm includes a model-based optimization algorithm.

23. An audio encoder according to claim 22, wherein the model-based optimization algorithm is a mixture model.

24. An audio encoder according to claim 23, wherein the mixture model is a Gaussian mixture model.

25. A method of encoding an audio signal (IN), the method comprising the steps of
performing a mathematical optimizing algorithm on a mathematical model of an audio encoding method taking a predetermined set of properties (PV) of the audio signal (IN) as input, for optimizing an encoding template of the encoding method with respect to a predetermined encoding efficiency criterion,
generating an optimized encoding template (OET) resulting from the mathematical optimizing algorithm, and
generating an encoded audio signal (OUT) in accordance with the optimized encoding template (OET).

26. A method of optimizing an encoding template (OET) of an audio encoder adapted to encode an audio signal (IN), the method comprising the steps of
receiving a predetermined set of properties (PV) of the audio signal (IN),
performing a mathematical optimizing algorithm on a mathematical model of an audio encoding method for optimizing the encoding template of the encoding method with respect to a predetermined encoding efficiency criterion, taking the predetermined set of properties (PV) of the audio signal (IN) as input, and
generating an optimized encoding template (OET) resulting from the mathematical optimizing algorithm.

27. A device comprising an audio encoder according to claim 14.

28. A computer readable program code adapted to encode an audio signal according to the method of claim 25.
